(19) United States
(12) Patent Application Publication
(10) Pub. No.: US 2025/0149811 A1
(43) Pub. Date: May 8, 2025

(54) CONNECTOR

(71) Applicant: SUMITOMO WIRING SYSTEMS, LTD., Mie (JP)

(72) Inventor: Koyo TAKASAKI, Mie (JP)

(21) Appl. No.: 18/935,247

(22) Filed: Nov. 1, 2024

(30) Foreign Application Priority Data
Nov. 6, 2023 (JP) 2023-189113

(51) Int. Cl. H01R 12/70; H01R 12/58; H01R 12/71; H01R 12/73

(52) U.S. Cl. CPC H01R 12/7035; H01R 12/58; H01R 12/716; H01R 12/732

(57) ABSTRACT

A connector includes a housing and a pair of terminal fittings accommodated in the housing. The terminal fittings respectively include board connection portions each protruding from a lower surface (one surface) of a terminal fixing portion of the housing and each positioned in a connection hole of the circuit board. The housing includes a plate-shaped insulating wall disposed between the board connection portions, which are adjacent to each other, and protruding downward from the lower surface (one surface) of the terminal fixing portion of the housing. A protruding end of the insulating wall is farther from the lower surfaceN (one surface) of the terminal fixing portion of the housing than protruding ends of the board connection portions are. The insulating wall is disposed in an insertion hole of the circuit board in a positioned state.

### CROSS-REFERENCE TO RELATED APPLICATIONS

This application is based on and claims priority from Japanese Patent Application No. 2023-189113, filed on Nov. 6, 2023, with the Japan Patent Office, the disclosure of which is incorporated herein in its entirety by reference.

### TECHNICAL FIELD

The present disclosure relates to a connector.

### BACKGROUND

JP H03-032376U1 discloses a high-voltage power supply connection member having a plurality of output protrusions protruding from a connector. This high-voltage power supply connection member is provided with ribs that separate adjacent output protrusions. With this configuration, the adjacent output protrusions are isolated from each other. A configuration similar to that disclosed in JP H03-032376U1 is also disclosed in JP 2005-050745A.

### SUMMARY

When a high-voltage power supply connection member such as that disclosed in JP H03-032376U1 is to be attached to a board, the output protrusions and the ribs are inserted into receiving holes and rib holes formed in the board. Considering the mating with the mating connection member, it is preferable to prevent the high-voltage power supply connection member from being misaligned with respect to the board.

In view of the above, an object of the present disclosure is to provide a connector that can improve the positioning accuracy with respect to the circuit board on which the connector is to be mounted, while ensuring a sufficient creepage distance between board connection portions.

A connector according to the present disclosure includes: a housing; and a plurality of terminal fittings accommodated in the housing, wherein the plurality of terminal fittings respectively include board connection portions each protruding from one surface of the housing and each positioned in a connection hole of a circuit board, the housing includes a plate-shaped insulating wall disposed between the board connection portions, which are adjacent to each other, and protruding from the one surface, a protruding end of the insulating wall is farther from the one surface of the housing than protruding ends of the board connection portions are, and the insulating wall is disposed in an insertion hole of the circuit board in a positioned state.

According to the present disclosure, it is possible to improve the positioning accuracy of a connector with respect to a circuit board on which the connector is to be mounted, while ensuring a sufficient creepage distance between board connection portions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view of a connector according to an embodiment.

FIG. 2 is a bottom cross-sectional view of the connector attached to a circuit board, as viewed from below.

FIG. 3 is a perspective view of a terminal fitting.

FIG. 4 is a perspective view of a terminal fixing portion of the connector, as viewed from below.

FIG. 5 is a side view of board connection portions of the connector attached to the circuit board, and an insulating wall, as viewed from the left.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, aspects of the present disclosure will be listed and described.
(1) A connector including: a housing; and a plurality of terminal fittings accommodated in the housing, wherein the plurality of terminal fittings respectively include board connection portions each protruding from one surface of the housing and each positioned in a connection hole of a circuit board, the housing includes a plate-shaped insulating wall disposed between the board connection portions, which are adjacent to each other, and protruding from the one surface, a protruding end of the insulating wall is farther from the one surface of the housing than protruding ends of the board connection portions are, and the insulating wall is disposed in an insertion hole of the circuit board in a positioned state.

The connector according to (1) is positioned by the insulating wall relative to the circuit board, and therefore the connector can be prevented from being misaligned with respect to the circuit board when the connector is to be attached to the circuit board. Here, the term “positioned state” refers to a state in which the insulating wall is disposed in the insertion hole so that the insulating wall does not wobble in a direction orthogonal to the direction in which the insertion hole passes.
(2) The connector according to (1), wherein the insulating wall has a plurality of wall surfaces each extending in a protruding direction in a planar shape, at least one of the plurality of wall surfaces is provided with a rib extending in the protruding direction and coming into contact with an inner circumferential surface of the connection hole, and a protruding leading end portion of the rib is provided with a sloped guide surface formed so as to be tapered toward a leading end.

The connector according to (2) can realize a configuration in which the wall surfaces do not come into contact with the inner circumferential surface of the insertion hole, but only the rib comes into contact therewith, making it easier to reduce insertion resistance when the insulating wall is inserted into the insertion hole. In addition, the sloped guide surface allows the rib to be inserted into the insertion hole without getting caught.
(3) The connector according to (2), wherein a protruding end portion of the insulating wall has a tapered surface formed so as to be tapered, and when viewed in a direction in which the board connection portions are lined up, the tapered surface is located outside contours of the board connection portions.

The connector according to (3) makes it easier to insert the insulating wall into the insertion hole and ensures a sufficient creepage distance between the board connection portions.
(4) The connector according to any one of (1) to (3), wherein the housing includes a recessed portion recessed from the one surface and surrounding a base end portion of the insulating wall, and the base end portion is provided with a curved surface that is sloped so that the base end portion is widen toward a bottom surface of the recessed portion within the recessed portion.

In the connector according to (4), the curved surface reinforces the base end portion of the insulating wall, and the curved surface is prevented from interfering with the insertion hole when the lower surface of the housing is brought closer to the circuit board, thereby making it less likely that the housing will tilt relative to the circuit board.

### Details of Embodiments of Present Disclosure

### First Embodiment

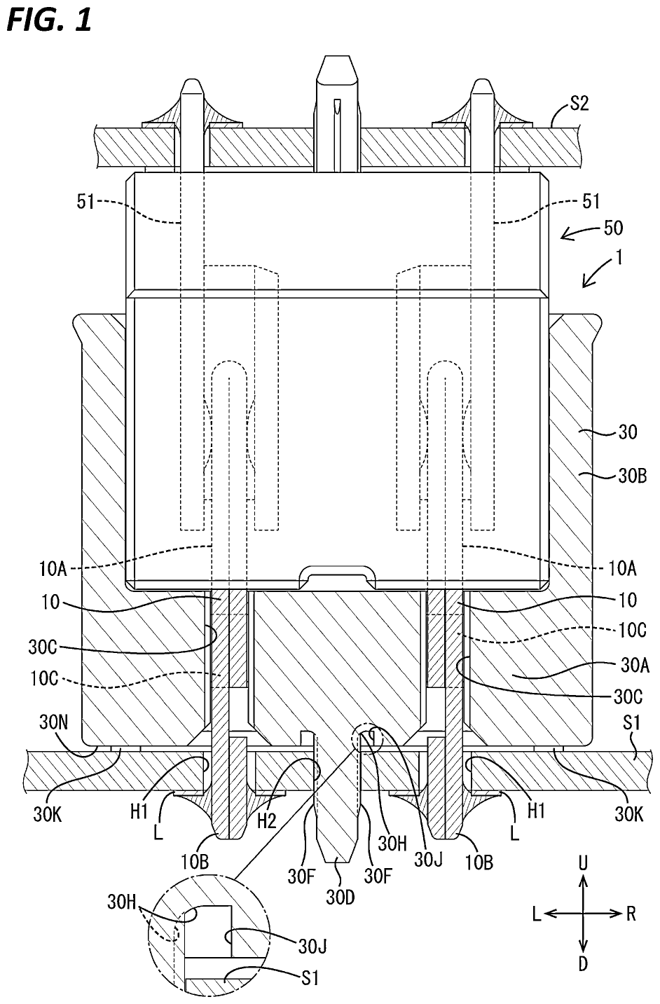

A first embodiment, which embodies a connector 1 according to the present disclosure, will be described with reference to FIGS. 1 to 5. In the figures, “front”, “back”, “up”, “down”, “right”, and “left side” are shown as “F”, “B”, “U”, “D”, “R”, and “L”, respectively. Note that the directional references are defined for the sake of convenience, and do not necessarily coincide with the directions when the connector 1 is mounted on a vehicle or the like. For example, the up-down direction is not limited to being the direction of gravity.

As shown in FIG. 1, the connector 1 can connect mating terminals 51 of a mating connector 50 attached to a circuit board S2 to terminal fittings 10 accommodated in a housing 30. The connector 1 includes the pair of terminal fittings 10 and the housing 30. The connector 1 is attached to a circuit board S1.

### Configuration of Circuit Board

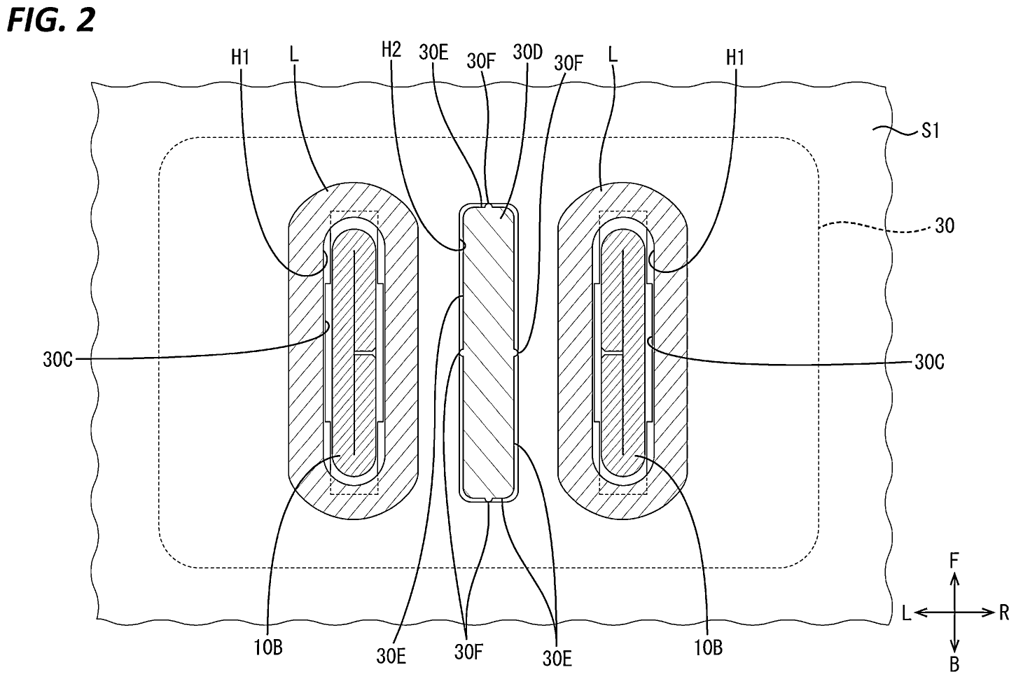

The circuit board S1 has a flat plate shape. Electronic components and the like (not shown) are mounted on the upper and lower surfaces of the circuit board S1. The circuit board S1 is provided with a pair of connection holes H1 and one insertion hole H2 passing through the circuit board S1 in the direction of the thickness thereof. As shown in FIG. 2, when the circuit board S1 is viewed from below, the pair of connection holes H1 and the one insertion hole H2 are elongated in one direction (front-back direction). Both end portions of each connection hole H1 of the pair of connection holes H1 in the longitudinal direction thereof are formed into a semicircular shape. The insertion hole H2 has a rectangular shape with four arc-shaped corners. The insertion hole H2 is disposed between the pair of connection holes H1. Conductive portions L are provided on the lower surface of the circuit board S1 so as to surround the connection holes H1, respectively. Board connection portions 10B of the terminal fittings 10, which are inserted into the connection holes H1 and protrude from the lower surface of the circuit board S1, are fixed to the conductive portions L by soldering (see FIG. 1), respectively.

### Configuration of Terminal Fittings

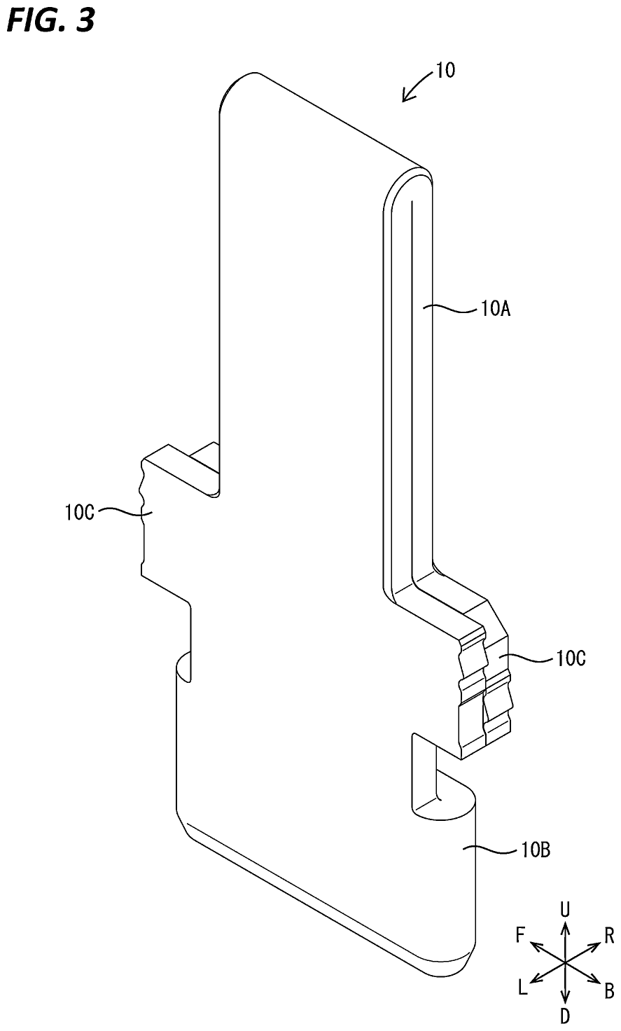

The terminal fittings 10 are formed by subjecting a conductive metal plate to press working or the like. The terminal fittings 10 are so-called male terminal fittings. The pair of terminal fittings 10 have the same shape. Therefore, the terminal fittings 10 will be described with reference to one terminal fitting 10 of the terminal fittings 10. As shown in FIG. 3, the terminal fitting 10 includes a tab 10A and a board connection portion 10B.

The tab 10A is elongated in the up-down direction by folding a metal plate so that the folded portions overlap each other in the direction of the thickness thereof. A lower end portion of the tab 10A is provided with a pair of locking pieces 10C, which protrude in the direction of the width of the tab 10A. The board connection portion 10B is formed to be continuous with the lower end edge of the tab 10A and extend downward. The board connection portion 10B is folded so that the folded portions overlap each other in the direction of the thickness thereof.

### Configuration of Housing

The housing 30 is made of synthetic resin. As shown in FIG. 1, the housing 30 includes a plate-shaped terminal fixing portion 30A whose thickness direction is oriented in the top-bottom direction, and a hood portion 30B having a rectangular tube shape and extending upward from the outer periphery of the terminal fixing portion 30A.

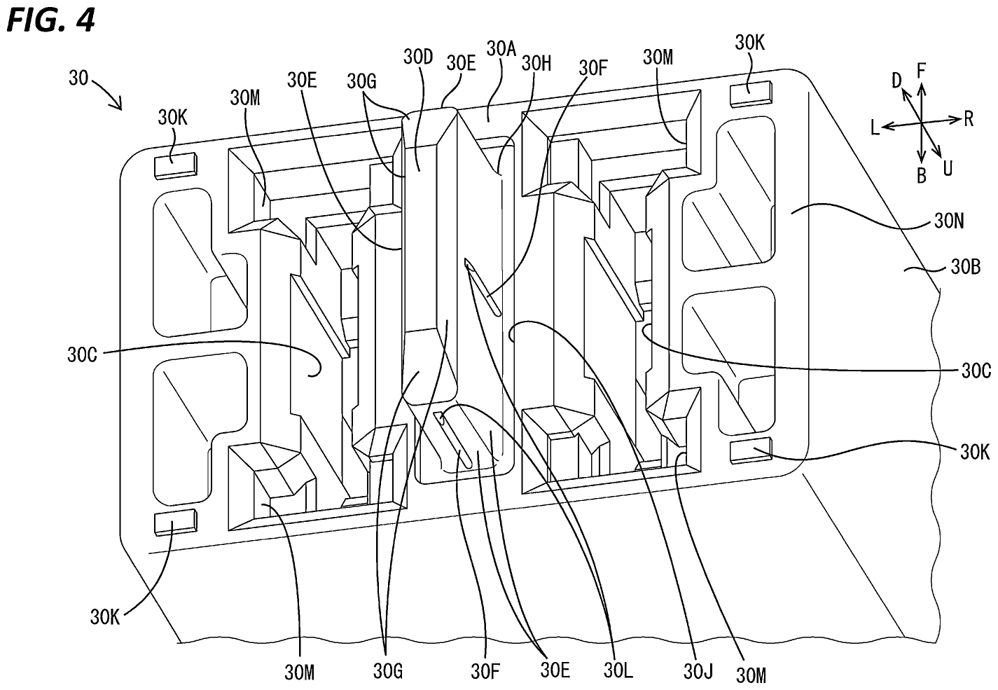

The terminal fixing portion 30A is provided with a pair of terminal insertion holes 30C passing through the terminal fixing portion 30A in the direction of the thickness thereof (up-down direction). As shown in FIG. 4, when the terminal fixing portion 30A is viewed in the direction of the thickness thereof (from below), the pair of terminal insertion holes 30C are elongated in one direction (front-back direction). Both end portions in the longitudinal direction (front and rear end portions) of the lower portion of each terminal insertion hole 30C are respectively provided with wide portions 30M that are wider than the upper portion of the terminal insertion hole 30C.

Each of the four corners of the terminal fixing portion 30A is provided with a leg portion 30K that protrudes downward from a lower surface 30N of the terminal fixing portion 30A (one surface of the housing 30).

The terminal fixing portion 30A is provided with a plate-shaped insulating wall 30D that protrudes downward from the lower surface 30N of the terminal fixing portion 30A. The insulating wall 30D is disposed between the pair of terminal insertion holes 30C. When the terminal fixing portion 30A is viewed from below, the insulating wall 30D has a rectangular shape with four arc-shaped corners (see FIG. 2). The insulating wall 30D has four wall surfaces 30E. Each wall surface 30E extends downward from the lower surface 30N of the terminal fixing portion 30A. In other words, the wall surfaces 30E face in different directions from each other and extend in a planar shape in the protruding direction (downward) in which the insulating wall 30D protrudes. When the terminal fixing portion 30A is viewed from below, the longitudinal direction of the pair of terminal insertion holes 30C and the insulating wall 30D extend in the same direction (front-back direction) (see FIG. 2).

The protruding end portion of the insulating wall 30D has four tapered surfaces 30G formed so as to be sloped and tapered toward the protruding end. The tapered surfaces 30G are respectively connected to the corresponding wall surfaces 30E.

Each wall surface 30E is provided with one rib 30F (see FIG. 2). Each rib 30F is formed to protrude in a semicircular shape from the corresponding wall surface 30E and extend in the up-down direction. In other words, each rib 30F extends in the protruding direction (up-down direction) in which the insulating wall 30D protrudes. Each rib 30F is disposed at the center in the width direction of the corresponding wall surface 30E (see FIG. 2). These ribs 30F are so-called crush ribs. A lower end portion (leading end portion) of each rib 30F has a sloped guide surface 30L formed so as to be sloped to approach the corresponding wall surface 30E and tapered toward the lower end (leading end). The lower end portion of each rib 30F is the end portion on the side away from the housing 30 in the protruding direction of the insulating wall 30D. Each sloped guide surface 30L is sloped so as to approach the corresponding wall surface 30E in a downward direction away from the lower surface 30N of the terminal fixing portion 30A of the housing 30. The leading end of each rib 30F is provided within the corresponding wall surface 30E above the corresponding tapered surface 30G.

The lower surface 30N of the terminal fixing portion 30A is provided with a recessed portion 30J that is recessed upward so as to surround a base end portion of the insulating wall 30D. The base end portion of the insulating wall 30D located in the recessed portion 30J is provided with a curved surface 30H that is sloped so that the base end portion is widen toward the bottom surface of the recessed portion 30J (see FIG. 1). Specifically, the curved surface 30H is a surface that is curved in a concave manner.

### Example of Attachment of Terminal Fittings to Housing

As shown in FIG. 1, the terminal fittings 10 are respectively inserted into the terminal insertion holes 30C from below the housing 30. Thereafter, the locking pieces 10C are respectively press-fitted into the terminal insertion holes 30C from below. Thus, the terminal fittings 10 are accommodated in the housing 30, and the connector 1 is completed.

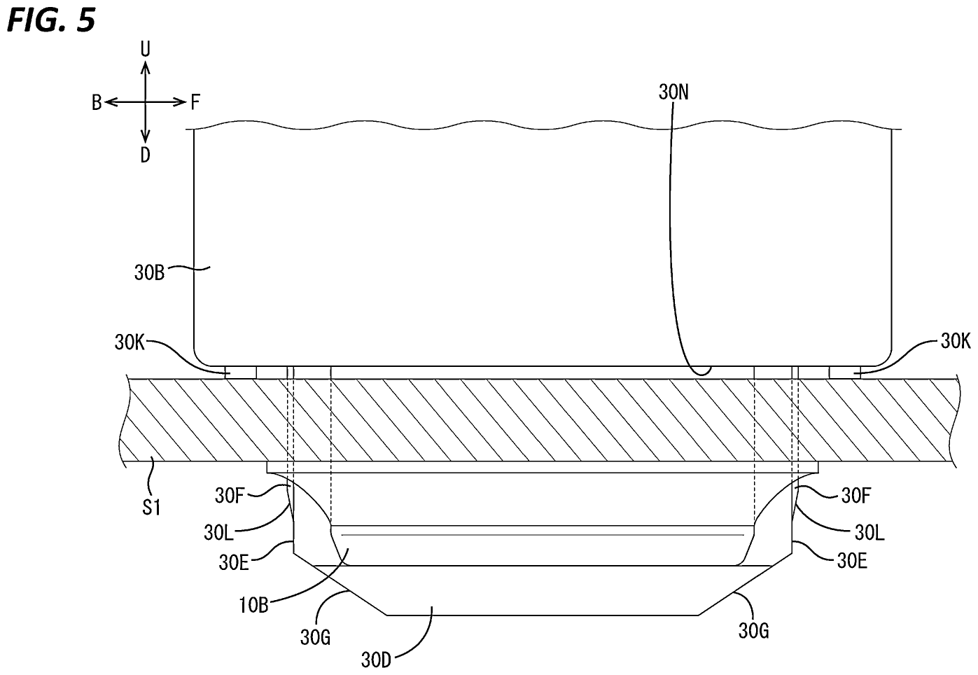

In the completed connector 1, the tabs 10A are disposed within the hood portion 30B. The board connection portions 10B protrude downward from the lower surface 30N of the terminal fixing portion 30A of the housing 30. The pair of board connection portions 10B and the insulating wall 30D are disposed so that their respective plate surfaces are parallel to each other. The insulating wall 30D is disposed between the board connection portions 10B, which are adjacent to each other (see FIG. 2). The protruding end of the insulating wall 30D is farther from the lower surface 30N of the terminal fixing portion 30A of the housing 30 than the protruding ends of the board connection portions 10B are. That is to say, the protruding dimension of the insulating wall 30D from the circuit board S1 is larger than the protruding dimension of the board connection portions 10B. As shown in FIG. 5, when viewed from the direction in which the board connection portions 10B are lined up, the contour of the insulating wall 30D is located outside the contours of the board connection portions 10B. The two end edges of the insulating wall 30D in the front-back direction are wider than the two end edges of each board connection portion 10B in the front-back direction. Specifically, the tapered surfaces 30G corresponding to the wall surfaces 30E at the two ends in the longitudinal direction are located outward of the contours of the board connection portions 10B.

### Example of Attachment of Connector to Circuit Board

First, the insulating wall 30D and the board connection portions 10B are brought close to the circuit board S1 from above. Thereafter, the insulating wall 30D of the housing 30 is inserted into the insertion hole H2 of the circuit board S1. Next, the board connection portions 10B of the terminal fittings 10 are simultaneously inserted into the connection holes H1 of the circuit board S1.

In the process of bringing the housing 30 closer to the upper surface of the circuit board S1, the insulating wall 30D is inserted into the insertion hole H2 while each rib 30F of the insulating wall 30D is slightly crushed by the inner circumferential surface of the insertion hole H2 (see FIG. 2). At this time, all the ribs 30F are slightly crushed. The wall surfaces 30E of the insulating wall 30D do not come into contact with the inner circumferential surface of the insertion hole H2 (see FIG. 2). In addition, in the process of bringing the housing 30 closer to the upper surface of the circuit board S1, the outer circumferential surface of each board connection portion 10B that faces the inner circumferential surface of the corresponding connection hole H1 does not come into contact with the inner circumferential surface of the connection hole H1 (see FIG. 2).

Thereafter, when the leg portions 30K of the housing 30 come into contact with the upper surface of the circuit board S1, the board connection portions 10B are connected and fixed to the conductive portions L of the circuit board S1 using solder. Thus, the connector 1 is attached to the circuit board S1 (see FIG. 1). At this time, portions of the board connection portions 10B are positioned in the connection holes H1 of the circuit board S1 (see FIG. 1). The remaining portions of the board connection portions 10B, other than the portions mentioned above, are located below the circuit board S1. In addition, a portion of the insulating wall 30D is disposed in a positioning state in which the ribs 30F are in contact with the inner circumferential surface of the insertion hole H2 of the circuit board S1 to prevent the insulating wall 30D from wobbling in a direction orthogonal to the penetration direction of the insertion hole H2 (see FIG. 2). The remaining portion of the insulating wall 30D, other than the portion mentioned above, is located below the circuit board S1. At this time, as shown in FIG. 5, when viewed from the direction in which the board connection portions 10B are lined up (left-right direction), the tapered surfaces 30G are located outside the contours of the board connection portions 10B so as not to overlap the contours of the board connection portions 10B. Note that, in FIG. 5, the board connection portion 10B on the far side of the drawing sheet relative to the insulating wall 30D is not shown.

Next, the mating connector 50 is inserted into the hood portion 30B from above. As a result, the mating terminals 51 (female terminal fittings) of the mating connector 50 and the terminal fitting 10 are connected (see FIG. 1).

Next, the effects of the first embodiment will be described.

The connector 1 includes a housing 30 and a pair of terminal fittings 10 accommodated in the housing 30. Each terminal fitting 10 includes a board connection portion 10B protruding from a lower surface 30N (one surface) of a terminal fixing portion 30A of the housing 30 and positioned in a connection hole H1 of the circuit board S1. The housing 30 includes a plate-shaped insulating wall 30D that is wide in the front- rear direction, is disposed between the board connection portions 10B, which are adjacent to each other, and protrudes downward from the lower surface 30N (one surface) of the terminal fixing portion 30A. The protruding end of the insulating wall 30D is farther from the lower surface 30N (one surface) of the terminal fixing portion 30A of the housing 30 than the protruding ends of the board connection portions 10B are. In other words, the insulating wall 30D protrudes longer than the board connection portions 10B with respect to the lower surface 30N (one surface) of the terminal fixing portion 30A. The insulating wall 30D is disposed in an insertion hole H2 of the circuit board S1 in a positioned state.

With this configuration, the connector 1 is positioned by the insulating wall 30D with respect to the circuit board S1, and therefore the connector 1 can be prevented from being misaligned with respect to the housing 30 when the connector 1 is to be attached to the circuit board S1.

The insulating wall 30D has a plurality of wall surfaces 30E each extending in the protruding direction in a planar shape and facing different directions from each other. Each of the plurality of wall surfaces 30E is provided with a rib 30F extending in the protruding direction and coming into contact with the inner circumferential surface of the insertion hole H2. A leading end portion of each rib 30F in the protruding direction is provided with a sloped guide surface 30L formed so as to be tapered toward the leading end. With this configuration, it is possible to realize a configuration in which the wall surfaces 30E do not come into contact with the inner circumferential surface of the insertion hole H2, but only the ribs 30F come into contact therewith, making it easier to reduce insertion resistance when the insulating wall 30D is inserted into the insertion hole H2. In addition, the sloped guide surfaces 30L enable the ribs 30F to be inserted into the insertion hole H2 without getting caught.

A protruding end portion of the insulating wall 30D has tapered surfaces 30G formed so as to be tapered, and when viewed in the direction in which the board connection portions 10B are lined up (left-right direction), the tapered surfaces 30G are located outside the contours of the board connection portions 10B. This configuration makes it easier to insert the insulating wall 30D into the insertion hole H2, and ensures a sufficient creepage distance between the board connection portions 10B.

The housing 30 includes a recessed portion 30J recessed upward from the lower surface 30N (one surface) of the terminal fixing portion 30A of the housing 30 and surrounding a base end portion of the insulating wall 30D. The base end portion of the insulating wall 30D is provided with a curved surface 30H that is sloped so that the base end portion is widen toward the bottom surface of the recessed portion 30J within the recessed portion 30J. With this configuration, the curved surface 30H reinforces the base end portion of the insulating wall 30D, and the curved surface 30H is prevented from interfering with the insertion hole H2 when the lower surface 30N of the terminal fixing portion 30A of the housing 30 is brought closer to the circuit board S1, thereby making it less likely that the housing 30 will tilt relative to the circuit board S1.

### Other Embodiments

The embodiments disclosed herein should be considered to be illustrative in all respects and not restrictive. The scope of the present invention is not limited to the embodiments disclosed herein, but is defined by the claims, and is intended to include all modifications within the meaning and scope of the claims.

The number of terminal fittings for the housing is not limited to the number in the above embodiment.

The present disclosure may be applied to a housing to which female terminal fittings that include board connection portions are attached.

Unlike the above embodiment, it is possible to employ a configuration in which the mating connection portions and the board connection portions are not folded back.

The number of wall surfaces of the insulating wall may be three or five or more.

The positions and number of the ribs on the wall surfaces are not limited to those in the above embodiment. For example, by providing ribs at both ends in the longitudinal direction (front-rear direction) of the wall surfaces located in the longitudinal direction, it is possible to effectively suppress misalignment of the connector in the rotational direction relative to the circuit board. In addition, it is sufficient to form a rib on at least one of the plurality of wall surfaces.

Unlike the above embodiment, the curved surface formed at the base end portion of the insulating wall may be a sloped surface that is sloped in a planar shape.

Unlike the above embodiment, the tapered surfaces may be curved surfaces that are continuous with the wall surfaces and curved outward.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing; and
a plurality of terminal fittings accommodated in the housing,
wherein the plurality of terminal fittings respectively include board connection portions each protruding from one surface of the housing and each positioned in a connection hole of a circuit board,
the housing includes a plate-shaped insulating wall disposed between the board connection portions, which are adjacent to each other, and protruding from the one surface,
a protruding end of the insulating wall is farther from the one surface of the housing than protruding ends of the board connection portions are, and
the insulating wall is disposed in an insertion hole of the circuit board in a positioned state.

2. The connector according to claim 1,
wherein the insulating wall has a plurality of wall surfaces each extending in a protruding direction in a planar shape,
at least one of the plurality of wall surfaces is provided with a rib extending in the protruding direction and coming into contact with an inner circumferential surface of the connection hole, and
a leading end portion of the rib in the protruding direction is provided with a sloped guide surface formed so as to be tapered toward a leading end.

3. The connector according to claim 2,
wherein a protruding end portion of the insulating wall has a tapered surface formed so as to be tapered, and
when viewed in a direction in which the board connection portions are lined up, the tapered surface is located outside contours of the board connection portions.

4. The connector according to claim 1,
wherein the housing includes a recessed portion recessed from the one surface and surrounding a base end portion of the insulating wall, and
the base end portion is provided with a curved surface that is sloped so that the base end portion is widen toward a bottom surface of the recessed portion within the recessed portion.
